(19) United States
(12) Patent Application Publication
(10) Pub. No.: US 2015/0293938 A1
(43) Pub. Date: Oct. 15, 2015

(54) REPLACING VIRTUAL FILE SYSTEM DATA STRUCTURES DELETED BY A FORCED UNMOUNT

(71) Applicant: HEWLETT-PACKARD DEVELOPMENT COMPANY, L.P., Houston, TX (US)

(72) Inventor: Jonathan Wesley Hittle, Ft. Collins, CO (US)

(21) Appl. No.: 14/410,660

(22) PCT Filed: Sep. 27, 2012
(86) PCT No.: PCT/US2012/057567

§ 371 Date: Dec. 23, 2014

(51) Int. Cl. G06F 17/30

(52) U.S. Cl. CPC G06F 17/30235; G06F 17/30082

(57) ABSTRACT

Examples disclosed herein relate to replacing virtual file system (VFS) data structures deleted by a forced unmount. Examples include storage in memory of a plurality of VFS data structures associated with file systems mounted in the VFS. Examples also include deletion of the VFS data structures associated with one of the file system by a forced unmount of the file system. Examples further include replacing the deleted data structures with linking data structures.

### BACKGROUND

A computing device may store information on at least one storage device associated with the computing device, such as a storage drive or flash memory, for example. The computing device may implement a file system and store the information on the storage device as files contained in respective directories of the file system. Additionally, a computing device may implement any of multiple different types of file systems.

### BRIEF DESCRIPTION OF THE DRAWINGS

The following detailed description references the drawings, wherein:

FIG. 1 is a block diagram of an example computing device to replace deleted virtual file system (VFS) data structures in response to identification of an orphan file system;

FIG. 2A is a block diagram of the example computing device of FIG. 1 comprising a memory to store a plurality of VFS data structures;

FIG. 2B is a block diagram of the example computing device of FIG. 2A in which the VFS data structures associated with a given file system are deleted from the memory;

FIG. 2C is a block diagram of the example computing device of FIG. 2B in which the linking data structures replace the deleted VFS data structures in the memory;

FIG. 3 is a block diagram of an example computing device to detect that a VFS path has been severed:

FIG. 4 is a flowchart of an example method for reconnecting a severed VFS path; and

FIG. 5 is a flowchart of an example method for replacing linking data structures with additional VFS data structures.

### DETAILED DESCRIPTION

As noted above, a computing device may implement any of multiple different types of file systems. In some examples, a computing device may implement a virtual file system (VFS) in which file systems of different types may be mounted. In such examples, the computing device may interact with the different types of mounted file systems through the VFS, which may handle the differences between the mounted file systems for the computing device.

In some examples, a given file system mounted in the VFS may have other file systems mounted under it. In such examples, if the given file system were unmounted from the VFS, any child file system mounted under the given file system would become an orphan having no connection to a root of the VFS, thus rendering the child file system, and thus the data stored therein, unreachable in the VFS by a typical lookup operation. Accordingly, a VFS may typically prevent an unmount operation from unmounting a file system having any other file system mounted under it. However, a VFS may also implement a forced unmount operation to force the VFS to unmount a specified file system regardless of whether any child file system is mounted under the specified file system.

In such examples, a forced unmount of a specified file system may render a child file system mounted under the specified file system an orphan file system by deleting VFS data structures associated with the specified file system. For example, a computing device implementing a VFS may store in memory a plurality of VFS data structures associated with each of the file systems mounted in the VFS. The VFS data structures may form respective VFS paths through which each of the mounted file systems may be reached via the VFS. In such examples, a forced unmount of a specified one of the file systems may delete the VFS data structures associated with the specified file system and thereby sever the VFS path to a child file system that was mounted under the specified file system.

To address these issues, examples described herein may detect a forced unmount of any given one of the file systems mounted in the VFS and, in response, identify a file system that was mounted under the given file system as an orphan file system. Additionally, in response to the identification of an orphan file system, examples described herein may replace the deleted VFS data structures with linking data structures to reconnect the severed VFS path to the orphaned file system. In this manner, examples described herein may enable a VFS to maintain access to file systems orphaned by a forced unmount of a file system mounted in the VFS.

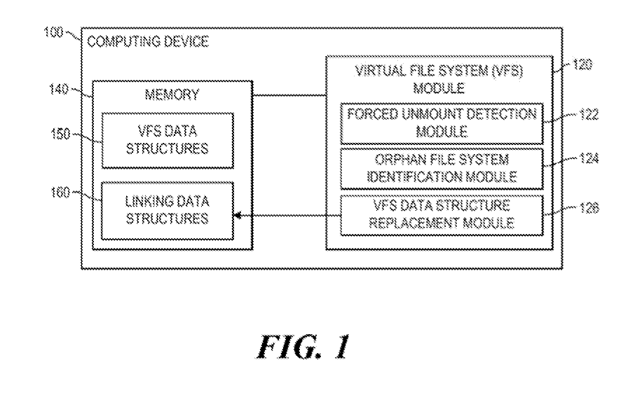

Referring now to the drawings, FIG. 1 is a block diagram of an example computing device 100 to replace deleted VFS data structures in response to identification of an orphan file system. As used herein, a “computing device” may be a desktop computer, notebook computer, tablet computer, server, workstation, mobile phone, smart device, or any other processing device or equipment.

In the example of FIG. 1, computing device 100 comprises a VFS module 120. VFS module 120 may include modules 122, 124, and 126. In some examples, VFS module 120 may include additional modules. The functionalities of VFS module 120, including the functionalities of modules 122, 124, and 126, and any other modules of VFS module 120, may be implemented in the form of executable instructions encoded on a machine-readable storage medium, in the form of electronic circuitry, or a combination thereof. In some examples, executable instructions implementing functionalities of selection module 120 may be stored on at least one machine-readable storage medium and executed by at least one processor of computing device 100. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof.

In the example of FIG. 1, computing device 100 may also include a memory 140. In some examples, memory 140 may be at least one machine-readable storage medium. As used herein, a “machine-readable storage medium” may be any electronic, magnetic, optical, or other physical storage device to contain or store information such as executable instructions, data, and the like. For example, any machine-readable storage medium described herein may be any of Random Access Memory (RAM), flash memory, a storage drive (e.g., a hard disk), a Compact Disc Read Only Memory (CD-ROM), and the like, or a combination thereof. Further, any machine-readable storage medium described herein may be non-transitory.

In the example of FIG. 1, computing device 100 may implement a VFS. For example, VFS module 120 of computing device 100 may implement the VFS. As used herein, a “virtual file system” (or “VFS”) of a computing device is a system to provide a generic interface through which applications of the computing device may interact with a plurality of file systems of different types. For example, an application of a computing device implementing a VFS may utilize a generic set of operations defined by the VFS to interact with each file system mounted in the VFS, regardless of the respective types of the file systems mounted in the VFS. In such examples, the VFS may translate generic VFS operations into file system-specific operations for each different type of file system mounted in the VFS. In some examples, the VFS may be part of an operating system (OS) of the computing device, or may otherwise interact with the OS. In the example of FIG. 1, VFS module 120 may be part of an OS of computing device 100, or otherwise interact with such an OS.

In the example of FIG. 1, VFS module 120 may store in memory 140 a plurality of VFS data structures 150 associated with file systems mounted in the VFS. As used herein, “VFS data structures” are data structures utilized by a VFS to represent and manage file systems mounted in the VFS. In examples described herein, VFS data structures include VFS mount structures and VFS nodes. As used herein, a “VFS mount structure” is a data structure to represent a file system mounted in a VFS, and a “VFS node” is a data structure to represent a file or directory of a file system mounted in the VFS. In some examples, a VFS node may be an inode, a vnode, or the like. In some examples, the VFS may also store a VFS root in memory 140. As used herein, a “VFS root” is a reference to a root file system mounted in the VFS. The root file system may be the highest level file system mounted in the VFS. In some examples, the VFS root may be a pointer to the root file system mounted in the VFS.

In some examples, VFS data structures 150 may form respective VFS paths from the VFS root to each of the file systems mounted in the VFS. As used herein, a “VFS path” is a reference or series of references maintained in a VFS that link the VFS root to a file system mounted in the VFS. For example, a VFS path may include a series of pointers to various VFS data structures 150 and a pointer from the last VFS data structure in the path to the mounted file system.

In some examples, VFS module 120 may receive a request to perform a forced unmount of a specified one of the file systems mounted in the VFS. In some examples, VFS module 120 may receive file forced unmount request in the form of an unmount request with an option, flag, parameter, or the like, specifying that a forced unmount be performed for the file system specified in the request. In other examples, the forced unmount request may be received in any other suitable manner. In response to the forced unmount request, VFS module 120 may unmount the specified file system from the VFS. In such examples, as part of the forced unmount of the specified file system, VFS module 120 may delete from memory 140 the VFS data structures 150 associated with the specified file system.

In the example of FIG. 1, forced unmount detection module 122 may detect the forced unmount of a mounted file system from the VFS. For example, module 122 may detect that VFS module 120 performed a forced unmount operation. In response to detection of the forced unmount of the specified file system, an orphan file system identification module 124 may identify, as an orphan file system, a file system that was mounted under the specified file system. For example, VFS module 120 may maintain in memory 140 a set of mounted file systems that includes a reference to each file system mounted in the VFS indexed by the directory path to the file system in the VFS. For example, the set of mounted file systems may comprise a hash table in which a reference (e.g., pointer) to a file system may be found based on a hash of the directory path of the file system (e.g., “/a/b”). In other examples, the set of mounted file systems may comprise a linked list of data structures, each including a reference to a mounted file system and the directory path of the file system.

In such examples, module 124 may identify an orphan file system by searching the set of mounted file systems for any file system whose directory path indicates that the file system was an immediate descendant of the specified file system unmounted by the detected forced unmount. As used herein, a “descendant” of a given file system is a file system mounted under the given file system either directly or indirectly. As used herein, a first file system is an “immediate descendant” of a second file system if the first file system is mounted directly under the second file system. In examples described herein, a first file system is mounted directly under a second file system if the first file system is mounted at a directory of the second file system. Also, in examples described herein, a first file system is indirectly mounted under a second file system if the first file system is mounted under a third file system mounted under the second file system. In examples described herein, no intervening file system is mounted between a first file system and a second file system that is an immediate descendant of the first file system.

For example, if the directory path for the unmounted file system was “/a”, then module 124 may search the set of mounted file systems and identify as an orphan file system any file system whose directory path indicates that it was an immediate descendant of the file system mounted at “/a”. In some examples, module 124 may first examine the set of mounted file systems to identify, as a descendant, any file system whose directory path begins with the directory path of the unmounted file system. For example, if the set of mounted file systems includes file systems mounted at “/”, “/d”, “/a/b”, and “/a/b/c”, then module 124 may identify the file systems mounted at directory paths “/a/b” and “/a/b/c”, respectively, as descendants of the file system that was mounted at “/a”. In some examples, module 124 may then identify as an immediate descendant any descendant whose directory path does not include (e.g., as a substring) the directory path of any other descendant. For example, module 124 may identify the file system at directory path “/a/b” as an immediate descendant of the unmounted file system, and thus identify it as an orphan file system. In such examples, module 124 may not identify the file system mounted at “/a/b/c” as an immediate descendant, since it includes “/a/b” as a substring.

In response to the identification of the orphan file system, a VFS data structure replacement module 126 may replace the VFS data structures deleted by the forced unmount (i.e., the VFS data structures associated with the unmounted file system) with linking data structures. In some examples, the VFS data structures deleted by the forced unmount may be the VFS data structures associated with the file system unmounted by the forced unmount. As used herein, “linking data structures” are data structures utilized by a VFS to reconnect a severed VFS path. In examples described herein, linking data structures include linking mount structures and linking nodes. As used herein, a “linking mount structure” is a data structure utilized by a VFS to replace a deleted VFS mount structure to at least partially reconnect a severed VFS path. Also, as used herein, a “linking node” is a data structure utilized by a VFS to replace a deleted VFS node to at least partially reconnect a severed VFS path.

As an example, VFS module 120 may perform a forced unmount to unmount a file system “a” mounted in the VFS at a directory path of “/a” in the VFS. In such examples, the forced unmount may delete a plurality of VFS data structures associated with the file system “a”. For example, the forced unmount may delete a VFS mount structure for the ile system, and a VFS node representing the root directory of file system “a”. In some examples, another file system “b” may be mounted under file system “a”. As used herein, a first file system mounted “under” a second file system means that the first file system is mounted in a directory of the second file system. In some examples, file system “b” may be mounted at a subdirectory “b” of file system “a” and thus at a directory path of “/a/b” in the VFS. In such examples, the forced unmount of file system “a” may also delete a VFS node representing a directory “b” in the unmounted file system (i.e. file system “a”).

In such examples, module 124 may identify the file system “b” (having a directory path of “/a/b”) as an orphan file system in response to module 122 detecting the forced unmount, as described above in relation to module 124. In response, module 126 may replace the deleted VFS mount structure with a linking mount structure and replace the deleted VFS nodes with two linking VFS nodes. Module 126 may also use the linking data structures to reconnect the VFS path tom the VFS root to file system “b” so that file system “b” is reachable in the VFS after file system “a” is unmounted. In some examples, each of the linking data structures may include a linking flag indicating that it is a linking data structure, and not a VFS data structure.

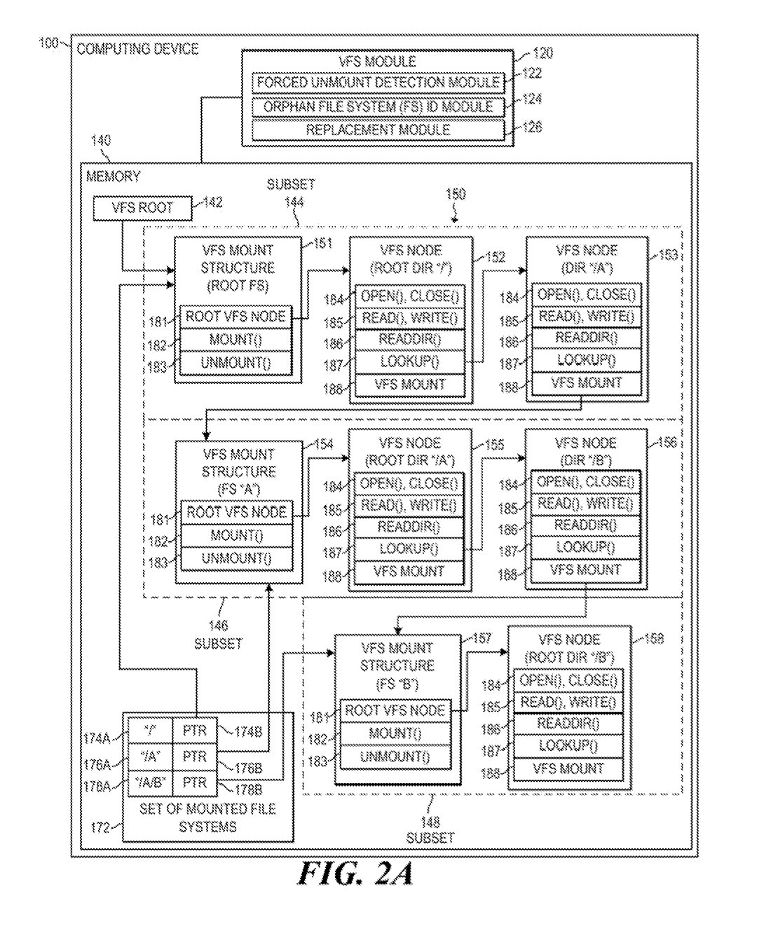

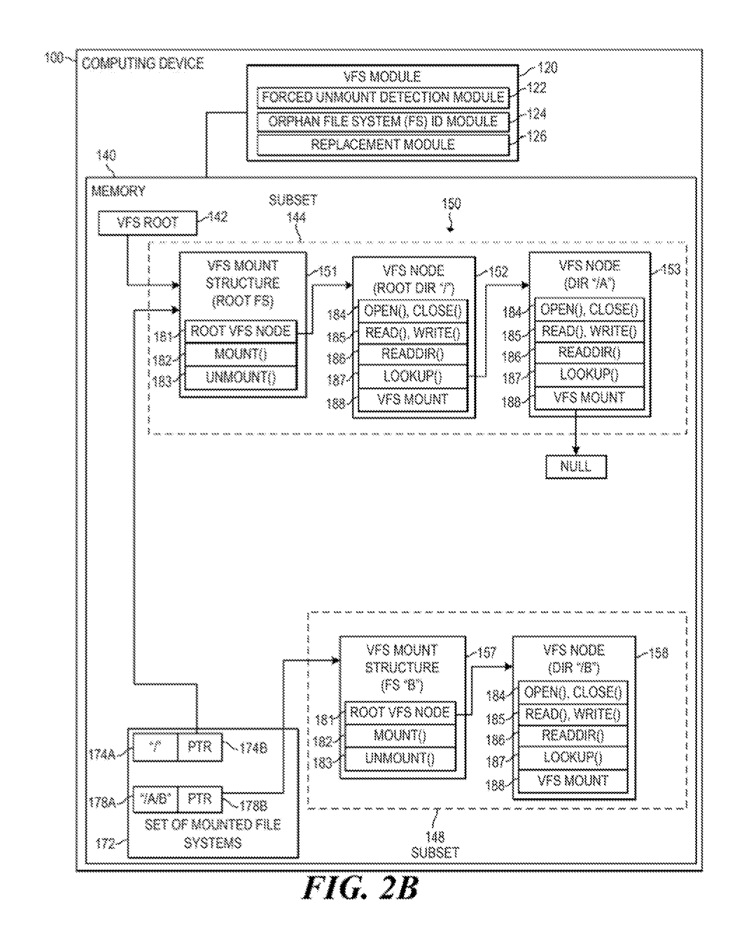

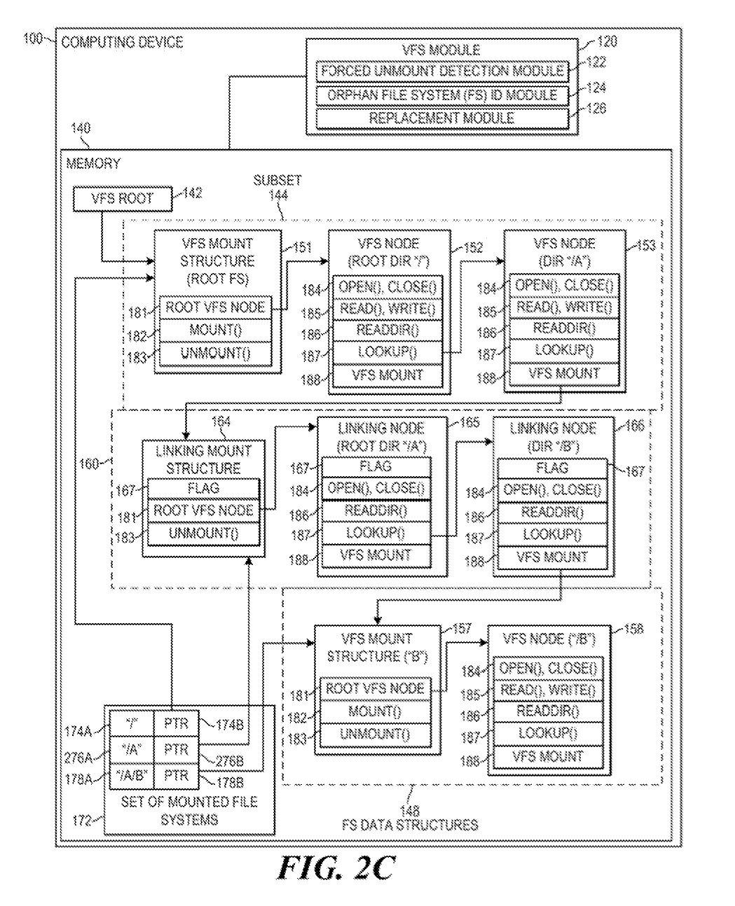

In examples described herein. VFS module 120 may implement a plurality of VFS mount structure components for the VFS mount structures. As used herein, “VFS mount structure components” are data structure components such as, for example, fields, routines, and the like. In some examples, the VFS may implement a subset of the VFS mount structure components for each linking mount structure. In such examples, VFS module 120 may implement some, but fewer than all, of the VFS mount structure components for the linking mount structure. As used herein, a data structure component is “implemented” for a data structure if accessing the data structure component (e.g., field, routine, etc.) in relation to the data structure does not result in an error (e.g., does not return an error code, or the like). Additionally, in some examples, VFS module 120 may implement a plurality of VFS node components for the VFS nodes. As used herein, “VFS node components” are data structure components such as, for example, fields, routines, and the like. In some examples, VFS module 120 may implement a subset of the VFS node components for each linking node. In some examples, functionalities described herein in relation to FIG. 1 may be provided in combination with functionalities described herein in relation to any of FIGS. 2A-5.

FIG. 2A is a block diagram of the example computing device 100 of FIG. 1 comprising a memory 140 to store a plurality of VFS data structures 150. In the example of FIG. 2A, computing device 100 comprises a VFS module 120 and a memory 140, as described above in relation to FIG. 1. VFS module 120 includes modules 122, 124, and 126, as described above in relation to FIG. 1. As described above in relation to FIG. 1, VFS data structures 150 may form respective VFS paths from a VFS root to each of the file systems mounted in the VFS. In some examples, each reference of each VFS path may be a pointer. Although in the examples of FIGS. 2A-2C, each reference of each VFS path is referred to as a pointer, in other examples, the references may be any other suitable type of reference.

In the example of FIG. 2A, VFS module 120 may mount a root file system in the VFS of computing device 100. In such examples, module 120 may create and store in memory 140 a VFS mount structure 151 to represent the root file system, and a VFS node 152 to represent a root directory “/” of the root file system. In the example of FIG. 2A. VFS module 120 may implement a plurality of VFS mount structure components for each VFS mount structure, including a root VFS node pointer 181, a mount routine 182, and an unmount routine 183. In such examples, root VFS node pointer 181 may point to the root VFS node for the root file system. In the example of FIG. 2A, root VFS node pointer 181 may point to VFS node 152, which represents the root directory of the root file system. Also, in the example of FIG. 2A, memory 140 includes a VFS root 142. In some examples, VFS root 142 may be a pointer (or other reference) to a root file system of the VFS. In the example of FIG. 2A. VFS root 142 may point to VFS mount structure 151.

In the example of FIG. 2A, VFS module 120 may implement a plurality of VFS node components for each VFS node, including VFS node 152. The plurality of VFS node components may include, for example, open and close routines 184, read and write routines 185, a read-directory routine 186, a lookup routine 187, and a VFS mount structure pointer (or reference) 188 (e.g., a “VFS mounted here” pointer). In some examples, VFS module 120 may also create and store in memory 140 a VFS node 153 to represent a subdirectory “a” under the root directory. As for all VFS nodes, VFS module 120 may implement VFS node components 184-188 for VFS node 153. In the example of FIG. 2A, a VFS node for a directory may not store pointers to other VFS nodes representing subdirectories or files in the directory, but may use lookup routine 187 to lookup a pointer or other reference to any VFS node representing a file or subdirectory under the directory represented by the given VFS node. For example, VFS node 152 may not store a pointer to VFS node 153, but may obtain a pointer to VFS node 153 by using lookup routine 187 to lookup subdirectory “a” in the root directory. In such examples, lookup routine 187 of VFS node 152 may first look in a directory name lookup cache (DNLC) for the pointer to subdirecory “a” and return it if found. In such examples, VFS module 120 may use the returned pointer to reach VFS node 153 from VFS node 152. In the example of FIG. 2A, a subset 144 of VFS date structures 150 associated with the root file system may include VFS mount structure 151 and VFS nodes 152 and 153.

VFS module 120 may also mount another file system “a” in the VFS of computing device 100. In such examples, module 120 may create and store in memory 140 a VFS mount structure 154 to represent file system “a”, and a VFS node 155 to represent a root directory (e.g., “/a”) of the file system “a”. In the example of FIG. 2A, VFS module 120 may mount file system “a” in directory “/a” of the root file system. In such examples, VFS module 120 may cause VFS mount structure pointer 188 of VFS node 153 to point to VFS mount structure 154. VFS module 120 may implement VFS mount structure components 181-183 for VFS mount structure 154, and may implement VFS node components 184-188 for VFS node 155. Root VFS node pointer 181 of VFS mount structure 154 may point to the root VFS node for the file system “a”, which is VFS node 155 representing the root directory of file system “a”.

VFS module 120 may also create and store in memory 140 a VFS node 156 to represent a subdirectory “b” under the root directory of file system “a”. VFS module 120 may implement VFS node components 184-188 for VFS node 156, as for all VFS nodes. In such examples, VFS node 155 may obtain a pointer to VFS node 156 when desired by using lookup routine 187 of VFS node 155 to lookup subdirectory “b” in the root directory of file system “a”. A subset 146 of VFS data structures 150 associated with the file system “a” include VFS mount structure 154 and VFS nodes 155 and 156.

Also, in the example of FIG. 2A, VFS module 120 may also mount another file system “b” in the VFS of computing device 100. In such examples, module 120 may create and store in memory 140 a VFS mount structure 157 to represent file system “b”, and a VFS node 158 to represent a root directory (e.g., “/b”) of the file system “b”. In the example of FIG. 2A, VFS module 120 may mount file system “b” in subdirectory “b” of the ile system “a” (i.e., at directory path “/a/b” in the VFS). In such examples, VFS module 120 may cause VFS mount structure pointer 188 of VFS node 156 to point to VFS mount structure 157. VFS module 120 may implement VFS mount structure components 181-183 for VFS mount structure 157, and implement VFS node components 184-188 for VFS node 158. Root VFS node pointer 181 of VFS mount structure 157 may point to the root VFS node for file system “b”, which is VFS node 158 representing the root directory of file system “b”. A subset 148 of VFS data structures 150 associated with the file system “b” includes VFS mount structure 157 and VFS node 158. In some examples, the VFS implemented by VFS module 120 may include additional files, directories, and file systems under any of the file systems mounted in the example of FIG. 2A.

In the example of FIG. 2A, VFS module 120 may also store in memory 140 a set of mounted file systems 172 that includes a reference to each VFS mount structure representing a file system mounted in the VFS, indexed by the directory path of file system (i.e., the VFS mount structure) in the VFS. In some examples, the set 172 may comprise a hash table in which a reference (e.g., pointer) to a VFS mount structure may be found based on a hash of the directory path (e.g., “/a/b”) of the represented file system. In other examples, the set of mounted file systems may comprise a linked list of data structures, each including a reference to a VFS mount structure representing a mounted file system and the directory path of the file system. In the example of FIG. 2A, in set 172, a pointer 1748 to the VFS mount structure of the root file system may be associated with directory path 174A (“/”) of the root file system. Additionally, a pointer 176B to the VFS mount structure representing file system “a” may be associated with directory path 176A (“/a”) of the file system “a”, and a pointer 178B to the VFS mount structure representing file system “b” may be associated with directory path 178A (“/a/b”) of the file system “b”.

In some examples, VFS module 120 may receive a request to perform a forced unmount of a specified one of the file systems mounted in the VFS, as described above in relation to FIG. 1. In response to the forced unmount request. VFS module 120 may unmount the specified file system from the VFS. In such examples, as part of the forced unmount of the specified file system, VFS module 120 may delete from memory 140 the VFS data structures 150 associated with the specified file system.

For example, in the example of FIG. 2A, VFS module 120 may receive a request to perform a forced unmount of file system “a” mounted at “/a” in the VFS and may unmount file system “a” in response. As part of the forced unmount of the specified file system, VFS module 120 may delete from memory 140 the subset 146 of VFS data structures 150 associated with file system “a”, as shown in FIG. 2B described below.

FIG. 2B is a block diagram of the example computing device 100 of FIG. 2A in which the VFS data structures 150 associated with a given file system are deleted from memory 140. In the example of FIG. 2B, computing device 100 comprises a VFS module 120 and a memory 140, as described above in relation to FIGS. 1 and 2A. As described above in relation to FIG. 2A, memory 140 may store VFS root 142, the set of mounted file systems 172, and VFS data structures 150.

Also, as described above in relation to FIG. 2A, in response to a request to perform a forced unmount of file system “a” mounted at “/a”. VFS module 120 may delete subset 146 of VFS data structures 150 associated with file system “a”. As shown in FIGS. 2A and 28, in such examples, VFS module 120 may, as part of the forced unmount, delete VFS mount structure 154, VFS node 155, and VFS node 156, each of which is associated with file system “a”. In the example of FIG. 2B, as part of the forced unmount, VFS module 120 may set VFS mount structure pointer 188 to null, since VFS mount structure 154 is deleted. VFS module 120 may also delete directory path 176A (“/a”) and corresponding pointer 176B from the set of mounted file systems 172, since VFS mount structure 154 is deleted.

In the example of FIG. 2B, forced unmount detection module 122 may detect the forced unmount of file system “a” from the VFS, as described above in relation to FIG. 1. In response to detection of the forced unmount of file system “a”, module 124 may identify a file system that was mounted under file system “a” as an orphan file system. In the example of FIG. 2B, module 124 may identify file system “b” as an orphan file system. For example, module 124 may search the set of mounted file systems 172 for any file system whose directory path indicates that the file system was an immediate descendant of file system “a”, which was unmounted by the detected forced unmount. In the example, module 124 may identify file system “b”, mounted at “/a/b”, as an orphan file system.

In such examples, the VFS path from VFS root 142 to the orphan file system “b” is severed by the deletion of the VFS data structures associated with the unmounted file system “a”. In such examples, after the forced unmount of file system “a”, VFS mount structure 157 representing file system “b” is no longer reachable from VFS root 142. As such, the forced unmount of file system “a” from the VFS renders file system “b” and the information stored therein unreachable via a typical lookup operation of the VFS. In response to the identification of the orphan file system, a VFS data structure replacement module 120 may replace the VFS data structures deleted by the forced unmount of file system “a” with linking data structures, as shown in FIG. 2C described below.

FIG. 2C is a block diagram of the example computing device 100 of FIG. 2B in which linking data structures 160 replace the deleted VFS data structures 150 in memory 140. In the example of FIG. 2C, computing device 100 comprises a VFS module 120 and a memory 140, as described above in reaction to FIGS. 1-28. As described above in relation to FIGS. 2A and 28, memory 140 may store VFS root 142, the set of mounted file systems 172, and VFS data structures 150.

As described above in relation to FIGS. 2A and 2B, the VFS path from VFS root 142 to the orphan file system “b” is severed by the deletion of the VFS data structures associated with file system “a”. In the example of FIGS. 2A-2C, in response to the identification of file system “b” as an orphan file system, a VFS date structure replacement module 126 may replace the VFS data structures deleted by the forced unmount of file system “a” with linking data structures 160, and reconnect the VFS path from VFS root 142 to orphan file system “b” with the linking data structures 160.

In the example of FIG. 2C, in response to identifying orphan file system “b”, module 126 may replace deleted VFS mount structure 154 with a linking mount structure 164, and replace deleted VFS nodes 155 and 156 with linking nodes 165 and 166, respectively. For example, module 126 may create and store in memory 140 linking mount structure 164 and linking nodes 165 and 166, and link them into the VFS path for file system “b” to thereby reconnect the VFS path for orphan file system “b”.

In the example of FIGS. 28 and 2C, after file system “b” having a directory path “/a/b” is identified as an orphan file system by module 124, module 126 may walk the VFS path for file system “b” as far as possible. In the example of FIGS. 28 and 20, module 126 may walk from VFS root 142, through VFS mount structure 151 and VFS node 152, and then to VFS node 153. At VFS node 153, representing subdirectory “/a” in the root file system, module 126 will find that VFS mount structure pointer 188 points to null, because ile system “a” was unmounted. Because VFS mount structure pointer 188 points to null, module 126 may attempt to find subdirectory “b” with the lookup routine 187 of VFS node 153. If “b” is not found, module 126 may identify that VFS mount structure pointer 188 of VFS node 153 is the location to which linking mount structure 164 replacing VFS mount structure 154 is to be mounted, and may cause VFS mount structure pointer 188 of VFS node 153 to point to linking mount structure 164.

In such examples, module 126 may also replace VFS node 155 representing the root directory of ile system “a” with a linking node 165, and cause the root VFS node pointer 181 of linking mount structure 164 to point to linking node 165. Module 126 may also create and store in memory 140 a linking node 166 to replace VFS node 156 representing the subdirectory “b” in file system “a”, since directory path 178A (“/a/b”) indicates that orphan file system “b” is mounted in a subdirectory “b” of file system “a”. In such examples, module 126 may update the DNLC so that lookup routine 187 of linking node 165 may return a pointer to linking node 166 when searching for directory “b”. Also, in the example of FIG. 2C, based on the directory path 178A (“/a/b”), module 126 may determine that linking node 166 representing the subdirectory “b” where orphan file system “b” was previously mounted should point to the VFS mount structure representing orphan file system “b”. In such examples, module 126 may cause VFS mount pointer 188 of linking node 166 to point to VFS mount structure 157 representing orphan file system V. Module 126 may also update the set of mounted file systems 172 to include a directory path 276A (“/a”) associated with a pointer 2768 pointing to linking mount structure 164.

In such examples, the linking data structures may reconnect the severed VFS path from VFS root 142 to mounted file system “b”, represented by VFS mount structure 157. In such examples, the reconnected VFS path may enable the VFS to reach the VFS data structures representing file system “b” via a typical lookup operation from VFS root 142, and thereby reach mounted file system “b” via the lookup operation. In the example of FIG. 2C, the reconnected VFS path may include VFS data structures 151-153, linking data structures 164-166, and VFS data structures 157 and 158.

In some examples, the linking mount structures of the VFS may be different than the VFS mount structures. As described above in relation to FIG. 1, VFS module 120 may implement a plurality of VFS mount structure components for the VFS mount structures. In some examples, VFS module 120 may implement a subset of the VFS mount structure components for each linking mount structure. In such examples, the subset may be non-empty and include fewer than all of the VFS mount structure components implemented for the VFS mount structures. In some examples, VFS module 120 may implement VFS mount structure components useful for reconnecting severed VFS paths.

In the example of FIGS. 2A-2C, for example, the plurality of VFS mount structure components implemented for VFS mount structures, such as VFS mount structures 151, 154, and 157, may include a root VFS node pointer 181, a mount routine 182, and an unmount routine 183. In some examples, the VFS mount structure components may also include other data structure components, such as freeze and thaw routines to stop and start input/output (I/O) operations to and from the file system represented by VFS mount structure, a quota routine indicating a per-user storage limit, and any other suitable routine, field, or other component.

In the example of FIG. 20, VFS module 120 may implement a subset of the VFS mount structure components for the linking mount structures. In such examples, VFS module 120 may implement some, but fewer than al, of the VFS mount structure components for the linking mount structures. For example, as shown in FIG. 2C, VFS module 120 may implement the root VFS node pointer 181 and unmount routine 183 for the linking mount structures, including linking mount structure 164. In such examples, VFS module 120 may not implement mount routine 182, or the freeze, thaw, or quota routines, for example. Also, in the example of FIG. 2C, each linking mount structure, such as linking mount structure 164, may include a linking data structure flag 167 to indicate that the linking mount structure is a linking data structure, and not a VFS data structure. In such examples, VFS module 120 may implement a flag for the linking mount structures, and, for each linking mount structure, set the flag to indicate that the linking mount structure is a linking data structure.

Additionally, in some examples, the inking nodes of the VFS may be different than the VFS nodes. As described above in relation to FIG. 1, VFS module 120 may implement a plurality of VFS node components for the VFS nodes. In some examples, VFS module 120 may implement a subset of the VFS node components for each linking node. In such examples, the subset may be non-empty and include fewer than all of the VFS node components implemented for the VFS nodes. In some examples, VFS module 120 may implement for the linking nodes the VFS node components useful for reconnecting severed VFS paths.

In the example of FIGS. 2A-2C, for example, the plurality of VFS node components implemented for VFS nodes, such as VFS nodes 152, 153, 155, 156, and 158, may include open and close routines 184, read and write routines 185, a read-directory routine 186, a lookup routine 187, and a VFS mount pointer 188. In some examples, the VFS node components may also include other data structure components, such as a create routine to create new files in a directory, a make-directory routine to make a new directory, a remove-directory routine to delete a directory, and any other suitable routine, field, or other component.

In the example of FIG. 2C, VFS module 120 may implement a subset of the VFS node components for the linking nodes. In such examples, VFS module 120 may implement some, but fewer than all, of the VFS node components for the linking nodes. For example, as shown in FIG. 2C, VFS module 120 may implement open and close routines 184, read-directory routine 186, lookup routine 187, and a VFS mount pointer 188 for the linking nodes, including linking nodes 165 and 166. In such examples, VFS module 120 may not implement read and write routines 185, or the create, make-directory, or remove-directory routines, for example. Also, in the example of FIG. 2C, each linking node, such as linking nodes 165 and 166, may include a linking data structure flag 167 to indicate that the linking node is a linking data structure, and not a VFS data structure. In such examples, VFS module 120 may implement a flag for the linking nodes, and, for each linking node, set the flag to indicate that the linking node is a linking data structure.

Although the examples of FIGS. 2A-2C are described above in relation to a forced unmount of file system “a”, computing device 100 may perform the functionalities described above in relation to the forced unmount of any other file system mounted in the VFS having a child file system mounted under it in the VFS. In some examples, functionalities described herein in relation to FIGS. 2A-2C may be provided in combination with functionalities described herein in relation to any of FIGS. 1 and 3-5.

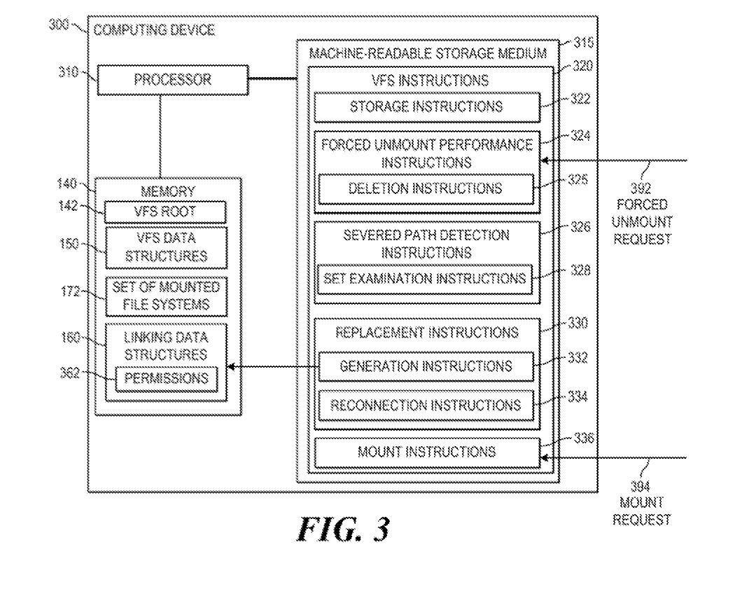

FIG. 3 is a block diagram of an example computing device 300 to detect that a VFS path has been severed. In the example of FIG. 3, computing device 300 includes a processor 310 and a machine-readable storage medium 315 encoded with instructions 320, 322, 324, 325, 326, 328, 330, 332, 334, and 336. In some examples, storage medium 315 may include additional instructions. Processor 310 may fetch, decode, and execute instructions stored on storage medium 315 to implement the functionalities described below. In other examples, the functionalities of any of the instructions of storage medium 315 may be implemented in the form of electronic circuitry, in the form of executable instructions encoded on a machine-readable storage medium, or a combination thereof.

In the example of FIG. 3, computing device 300 may also include a memory 140, as described above in relation to FIGS. 1-20. Memory 140 may store a VFS root 142. VFS data structures 150, and a set of mounted file systems 172, as described above in relation to FIGS. 1-2C. In the example of FIG. 3, computing device 300 may implement a VFS. For example, VFS instructions 320 may implement the VFS of computing device 300.

Storage instructions 322 may store in memory 140 a plurality of VFS data structures 150 associated with file systems mounted in the VFS and forming respective VFS paths from VFS root 142 to each of the mounted file systems, as described above in relation to FIGS. 1-2C. Instructions 324 may perform a forced unmount of a first one of the file systems under which a second one of the file systems is mounted. In some examples, instructions 324 may perform the forced unmount of the first file system in response to a forced unmount request 392 received (e.g., from a user) by instructions 324. The request 392 may specify that the first file system be unmounted.

In some examples, as part of the forced unmount of the first file system, deletion instructions 325, of instructions 324, may delete the VFS data structures 150 associated with the first file system from memory 140. In such examples, the deletion of the VFS data structures 150 associated with the first file system may sever the VFS path from VFS root 142 to the second file system, as described above in relation to FIGS. 2A-2C. For example, as part of the forced unmount of the first file system, instructions 325 may delete a VFS mount structure associated with the first file system, and delete at least one VFS node, such as a VFS node representing a root directory of the first file system. In some examples, instructions 325 may also delete an additional VFS node, such as a VFS node representing a subdirectory of the first file system at which the second file system is mounted. Referring to FIG. 2A, for example, if the first file system is file system “a” and the second file system is file system “b”, then instructions 325 may delete a VFS mount structure 154 associated with the first file system, delete VFS node 155 representing the root directory of the first file system, and delete VFS node 156 representing a directory of the first file system at which the second file system is mounted. In such examples, the deletion of the VFS data structures 150 by instructions 325 may sever the VFS path from VFS root 142 to the second file system (i.e., file system “b”), as shown in FIG. 2B.

In the example of FIG. 3, instructions 326 may detect that the VFS path from VFS root 142 to the second file system has been severed. In some examples, instructions 326 may detect the performance of the forced unmount, as described above in relation to FIG. 1. In response to detecting the performance of the forced unmount, instructions 328 may examine the set of file mounted systems 172 to determine whether any of the VFS paths have been severed. In some examples, instructions 328 may determine that a VFS path has been severed by identifying an orphan file system, as described above in relation to FIG. 1. In such examples, instructions 328 may determine that the VFS path to the orphan file system has been severed.

In other examples, instructions 326 may detect a failed lookup operation of the VFS and, in response, instructions 328 may examine the set of mounted file systems 172 to determine whether any of the VFS paths have been severed. In such examples, instructions 326 may not identify an orphan file system or detect a severed VFS path in response to the forced unmount, but may instead determine whether a VFS path has been severed in response to a failed lookup. For example, after a forced unmount of the first file system, VFS instructions 320 may receive a request to lookup a file or directory in or under the second file system (which was mounted under the first file system). In such examples, the lookup operation will fail when the lookup operation reaches a VFS node that previously pointed to VFS data structure associated with the unmounted first file system. In response to the failed lookup. Instructions 328 may search the set of mounted file systems 172 for the shortest directory path that would allow the lookup operation to continue from the point at which it failed. In response to identifying such a directory path in the set 172, instructions 328 may determine that the VFS path to the second file system has been severed.

For example, referring to FIGS. 2A and 28, for example, after a forced unmount of file system “a”, VFS instructions 320 may receive a request to look up the directory at directory path “/a/b”. In such examples, referring to FIG. 2B, the lookup operation may fail at VFS node 153 when instructions 320 determine that the VFS mount pointer 188 of VFS node 153 points to null and that lookup routine 187 of VFS node 153 does not return a directory “b”. In response to the failed lookup, instructions 328 may search the set of mounted file systems 172 for the shortest directory path that would allow the lookup operation to continue from the point at which it failed. In the example of FIG. 2B. Instructions 328 would identify directory path 178A (“/a/b”), which would allow the lookup to continue from where the lookup failed (i.e., “/a”). After identifying directory path 178A in the set 172, instructions 328 may determine that the VFS paths to file system “b” has been severed.

In the example of FIG. 3, in response to detection of the severance of a VFS path, instructions 330 may replace the deleted VFS data structures with linking data structures, as described above in relation to FIGS. 1-2C. In some examples, the inking data structures may reconnect the severed VFS path from VFS root 142 to the mounted second file system. In such examples, the reconnected VFS path may enable the VFS to reach the VFS data structures representing second file system from VFS root 142, and thereby reach second file system via a typical lookup operation, as described above in relation to FIG. 2C.

In some examples, instructions 330 may include generation instructions 332 and reconnection instructions 334. In such examples, in response to detection of the severance of a VFS path, instructions 332 may generate a linking mount structure and at least one inking node. In some examples, instructions 332 may generate a linking mount structure and first and second linking nodes. In some examples, VFS instructions 320 may implement fewer VFS mount structure components for the linking mount structure than it implements for a VFS mount structure, such as the VFS mount structure deleted by the forced unmount and which the linking mount structure is replacing. VFS instructions 320 may also implement fewer VFS mount structure components for the first linking node than for a VFS node, such as the first VFS node deleted by the forced unmount. In such examples, VFS instructions 320 may also implement fewer VFS mount structure components for the second linking node than for a VFS node, such as the second VFS node deleted by the forced unmount. In such examples, the generated linking mount structure and linking nodes are each linking data structures 160, which instructions 332 may store in memory 140. Also, in some examples, instructions 332 may generate each of the linking mount structure and the first and second linking nodes with read and execute permissions 362.

Referring to FIGS. 2A-2C, for example, in response to detection of the severance of a VFS path from VFS root 142 to file system “b” mounted at directory path “a/b”, generation instructions 332 may generate linking mount structure 164 for which fewer VFS mount structure components are implemented than for a VFS mount structure 154 deleted by the forced unmount. Instructions 332 may also generate linking node 165 for which fewer VFS node components are implemented than for VFS node 155 deleted by the forced unmount, and linking node 166 for which fewer VFS node components are implemented than for VFS node 156 deleted by the forced unmount.

In the example of FIG. 3, instructions 334 may reconnect the severed VFS path with the linking mount structure and the first and second linking nodes generated by instructions 332. In such examples, instructions 334 may use pointers of the VFS to reconnect the severed VFS path with the linking data structures generated by instructions 332. Referring to FIG. 2C, for example, after generating linking data structures 160, including linking data structures 164-166, instructions 334 may cause VFS mount pointer 188 of VFS node 153 to point to linking mount structure 164, and cause root VFS node pointer 181 of linking mount structure 164 to point to linking node 165. Additionally, instructions 334 may update the DNLC to that lookup routine 187 of linking node 165 returns a pointer to linking node 166 in response to a lookup for directory “b”. Instructions 334 may also cause VFS mount structure pointer 188 of linking node 166 to point to VFS mount structure 157, which represents file system “b”.

In the example of FIG. 3, mount instructions 336 may receive a request 394 to mount a given file system at a specified location in the VFS from which the given file system was unmounted by the forced unmount. For example, if a network file system (NFS) goes offline, a user may accordingly use a forced unmount to unmount the NFS from the VFS, regardless of whether any other file system is mounted under the NFS. However, the user may wish to remount the NFS when it comes back online. In such examples, a user may provide a mount request 394 to remount the unmounted file system.

In response to the mount request 394, instructions 336 may detect a linking data structure mounted at the specified location in the VFS. Referring to FIG. 2C, for example, file system “a” may be unmounted by a forced unmount, as described above in relation to FIGS. 2A-2C, and mount request 394 may subsequently request to remount file system “a” at directory path “/a” in VFS. In such examples, instructions 336 may perform a lookup of directory path “/a” as part of the mount process, and determine at VFS node 153 that something is already mounted at “/a”. In such examples, instructions 336 may follow VFS mount structure pointer 188 of VFS node 153 to linking mount structure 164 and determine from flag 167 of linking mount structure 164 that the mount structure 164 is a linking data structure.

In response to detecting the linking data structure, instructions 336 may replace the linking data structures that replaced the deleted VFS data structures associated with file system “a” with additional VFS data structures associated with the given file system to be mounted (i.e., file system “a”). In such examples, the linking data structures may include a linking mount structure and a plurality of linking nodes, and the additional VFS data structures may include an additional VFS mount structure representing the given file system and a plurality of additional VFS nodes representing directories of the given file system.

In such examples, instructions 336 may store in memory 140 a VFS mount structure for the file system to be mounted. In the example of FIGS. 2A-2C, the additional VFS mount structure may be equivalent to previously deleted VFS mount structure 154 of FIG. 2A. Instructions 336 may also replace at least one linking node of the VFS representing a directory of an unmounted file system with additional VFS nodes representing corresponding directories in the file system being mounted. In such examples. Instructions 336 may store each additional VFS node in memory by performing, on the file system to be mounted, a lookup operation for a directory of the file system. Accordingly, in some examples, instructions 336 may first determine what directory paths to look up in the file system to create the appropriate additional VFS nodes to replace the linking nodes.

In some examples, instructions 336 may first determine what directory paths to look up by searching the set of mounted file systems 172 for the file systems that are to be immediate descendants of the given file system being mounted at the directory path specified by the mount request. In some examples, the immediate descendants may be identified as described above in relation to FIG. 1. In the example of FIGS. 2A-2C, instructions 336 may determine that the file system mounted at directory path 178A (“/a/b”) is to be an immediate descendant of the given file system being mounted at “/a”. In other examples, replacement instructions 330 may maintain a tree of all of the linking data structures of the VFS. In such examples, instructions 336 may determine what directory paths to look up based on the linking nodes referenced in the tree.

After determining the paths to look up in the file system to be mounted, instructions 336 may then look up the appropriate directories in the file system to bring the appropriate additional VFS nodes into memory 140. In the example of FIGS. 2A-2C, for example, instructions 336 may look up directory path “/a” in the file system to retrieve a VFS node to replace linking node 165, representing the root directory of the unmounted file system. This VFS node may be equivalent to VFS node 155 of FIG. 2A. Instructions 336 may also look up subdirectory “b” under “/a” in the file system to retrieve an additional VFS node to replace linking node 166, representing subdirectory “b” in the unmounted file system. This VFS node may be equivalent to VFS node 156 of FIG. 2A. Since the VFS node equivalent to VFS node 156 would be a mount point for file system “b”, its VFS mount structure pointer 188 may be copied from VFS mount structure pointer 188 of linking node 186, to point to VFS mount structure 157. Instructions 336 may also cause the VFS mount structure pointer 188 of VFS node 153 and pointer 2768 to each point to the additional VFS mount structure (e.g., equivalent to VFS mount structure 154) of the file system to be mounted. In some examples, functionalities described herein in relation to FIG. 3 may be provided in combination with functionalities described herein in relation to any of FIGS. 1-2C and 4-5.

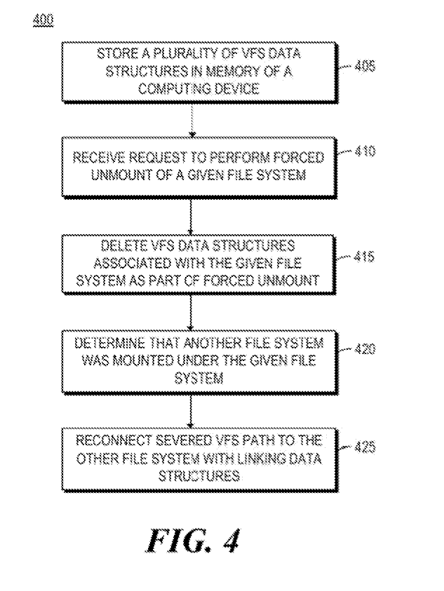

FIG. 4 is a flowchart of an example method 400 for reconnecting a severed VFS path. Although execution of method 400 is described below with reference to computing device 300 of FIG. 3, other suitable components for execution of method 400 can be utilized (e.g., computing device 100). Additionally, method 400 may be implemented in the form of executable instructions encoded on a machine-readable storage medium, in the form of electronic circuitry, or a combination thereof.

At 405 of method 400, computing device 300 may store in memory 140 a plurality of VFS data structures 150 associated with file systems mounted in a VFS implemented by computing device 300. In such examples, the VFS data structures 150 may form respective VFS paths from a VFS root 142 to each of the mounted file systems. At 410, computing device 300 may receive a request 392 to perform a forced unmount of a given one of the file systems. At 415, as part of the requested forced unmount, computing device 300 may, with processor 310, delete from memory 140 the VFS data structures 150 associated with the given file system.

At 420, in response to detecting performance of the forced unmount, computing device 300 may determine that another of the mounted file systems was mounted under the given file system. In such examples, deletion of the VFS data structures 150 associated with the given file system may sever the VFS path from VFS root 142 to the other file system. At 425, computing device 300 may reconnect the severed VFS path from VFS root 142 to the other file system with a plurality of linking data structures replacing the deleted VFS data structures, as described above in relation to FIGS. 1-3. In some examples, functionalities described herein in relation to FIG. 4 may be provided in combination with functionalitles described herein in relation to any of FIGS. 1-3 and 5.

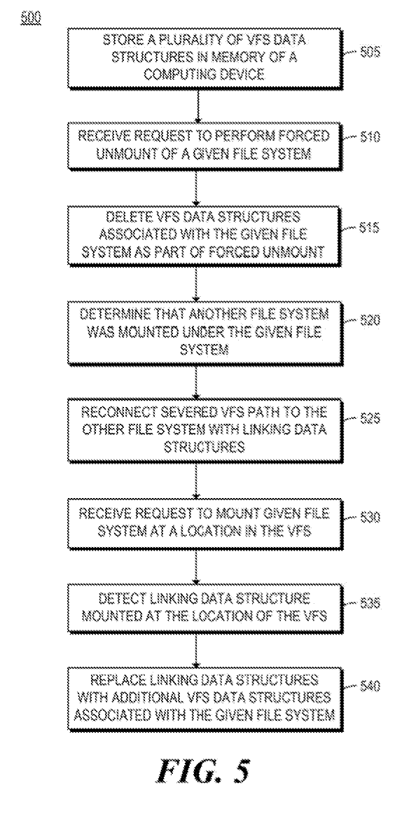

FIG. 5 is a flowchart of an example method 500 for replacing linking data structures with additional VFS data structures. Although execution of method 500 is described below with reference to computing device 300 of FIG. 3, other suitable components for execution of method 500 can be utilized (e.g., computing device 100). Additionally, method 500 may be implemented in the form of executable instructions encoded on a machine-readable storage medium, in the form of electronic circuitry, or a combination thereof.

At 505 of method 500, computing device 300 may store in memory 140 a plurality of VFS data structures 150 associated with file systems mounted in a VFS implemented by computing device 300. The VFS data structures 150 may form respective VFS paths from a VFS root 142 to each of the mounted file systems. At 510, computing device 300 may receive a request 392 to perform a forced unmount of a given one of the file systems. At 515, as part of the requested forced unmount, processor 310 may delete from memory 140 the VFS data structures 150 associated with the given file system.

At 520, in response to detecting performance of the forced unmount, computing device 300 may determine that another of the mounted file systems was mounted under the given file system. In such examples, deletion of the VFS data structures 150 associated with the given file system may sever the VFS path from VFS root 142 to the other file system. At 525, computing device 300 may reconnect the severed VFS path from VFS root 142 to the other file system with a plurality of linking data structures replacing the deleted VFS data structures, as described above in relation to FIGS. 1-3.

At 530, computing device 300 may receive a request 394 to mount the given file system at a location in the VFS from which the given file system was unmounted by the forced unmount. In response, at 535, computing device 300 may detect one of the linking data structures mounted at the location in the VFS, as described above in relation to FIG. 3. At 540, in response to detecting one of the linking data structures, computing device 300 may replace the linking data structures with additional VFS data structures associated with the given file system, as described above in relation to FIG. 3. In such examples, the linking data structures may include a linking mount structure and a plurality of linking nodes and the additional VFS data structures include an additional VFS mount structure representing the given file system and a plurality of additional VFS nodes representing directories of the given file system. In some examples, functionalities described herein in relation to FIG. 5 may be provided in combination with functionalities described herein in relation to any of FIGS. 1-4.

What is claimed is:

1. A computing device to implement a virtual file system (VFS), the computing device comprising:
a memory to store a plurality of VFS data structures associated with file systems mounted in the VFS and forming respective VFS paths from a VFS root to each of the mounted file systems;
a forced unmount detection module to detect a forced unmount of any given one of the file systems from the VFS, wherein the VFS data structures associated with the given file system are deleted from the memory by the forced unmount;
an orphan file system identification module to, in response to detection of the forced unmount, identify one of the file systems that was mounted under the given file system as an orphan file system; and
a VFS data structure replacement module to replace the deleted VFS data structures with linking data structures in response to the identification of the orphan file system.

2. The computing device of claim 1, wherein:
the VFS path from the VFS root to the orphan file system is severed by the deletion of the VFS data structures associated with the given file system; and
the replacement module is further to reconnect the VFS path from the VFS root to the orphan file system with the linking data structures.

3. The computing device of claim 2, wherein the VFS data structures associated with the given file system comprise:
a VFS mount structure representing the given file system, wherein a plurality of VFS mount structure components are implemented for the VFS mount structure; and
a plurality of VFS nodes, each representing a directory in the VFS, wherein a plurality of VFS node components are implemented for each of the VFS nodes.

4. The computing device of claim 3, wherein the linking data structures comprise:
a linking mount structure, wherein a first subset of the VFS mount structure components are implemented for the linking mount structure, and wherein the first subset is non-empty and includes fewer than al of the VFS mount structure components; and
a plurality of linking nodes, wherein a second subset of the VFS node components are implemented for each of the linking nodes, wherein the second subset is non-empty and includes fewer than all of the VFS node components.

5. The computing device of claim 4, wherein:
the linking mount structure includes a linking data structure flag; and
the first subset comprises:
a root VFS node pointer; and
a VFS mount structure unmount routine.

6. The computing device of claim 4, wherein:
each of the linking nodes includes a linking data structure flag; and
the second subset comprises:
a VFS node lookup routine;
a VFS node read-directory routine;
a VFS node open routine; and
a VFS node close routine.

7. A non-transitory machine-readable storage medium encoded with instructions executable by a processor of a computing device to implement a virtual file system (VFS), the storage medium comprising instructions to:
store in memory of the computing device a plurality of VFS data structures associated with file systems mounted in the VFS and forming respective VFS paths from a VFS root to each of the mounted file systems;
perform a forced unmount of a first one of the file systems under which a second one of the file systems is mounted, the forced unmount comprising deletion of the VFS data structures associated with the first file system from the memory, wherein the VFS path from the VFS root to the second file system is severed by the deletion;
detect that the VFS path from the VFS root to the second file system has been severed; and
replace the deleted VFS data structures with linking data structures in response to detection of the severance of the VFS path, wherein the linking data structures reconnect the severed VFS path.

8. The storage medium of claim 7, wherein the instructions to detect comprise instructions to:
detect the performance of the forced unmount; and
in response to the detection of the forced unmount, examine a set of file systems mounted in the VFS to determine whether any of the VFS paths have been severed.

9. The storage medium of claim 7, wherein the instructions to detect comprise instructions to:
detect a failed lookup operation of the VFS; and
in response to the detection of the failed lookup operation, examine a set of file systems mounted in the VFS to determine whether any of the VFS paths have been severed.

10. The storage medium of claim 7, wherein the instructions to perform the forced unmount comprise instructions to:
delete a VFS mount structure associated with the first file system;
delete a first VFS node representing a root directory of the first file system; and
delete a second VFS node representing a directory of the first file system at which the second file system is mounted.

11. The storage medium of claim 10, wherein the instructions to replace comprise instructions to:
generate a linking mount structure for which fewer VFS mount structure components are implemented than for the VFS mount structure;
generate a first linking node for which fewer VFS node components are implemented than for the first VFS node; and
generate a second linking node for which fewer VFS node components are implemented than for the second VFS node, wherein the linking data structures include the linking mount structure and the first and second linking nodes.

12. The storage medium of claim 11, wherein:
the instructions to replace further comprise instructions to reconnect the severed VFS path with the linking mount structure and the first and second linking nodes; and
each of the linking mount structure and the first and second linking nodes have read and execute permissions.

13. A method comprising:
storing, in memory of a computing device to implement a virtual file system (VFS), a plurality of VFS data structures associated with file systems mounted in the VFS and forming respective VFS paths from a VFS root to each of the mounted file systems;
receiving a request to perform a forced unmount of a given one of the file systems;
deleting from the memory, with a processor of the computing device, the VFS data structures associated with the given file system as part of the requested forced unmount;
determining that another of the file systems was mounted under the given file system, in response to detecting performance of the forced unmount, wherein the VFS path from the VFS root to the other file system is severed by the deletion of the VFS data structures associated with the given file system; and
reconnecting the severed VFS path from the VFS root to the other file system with a plurality of linking data structures replacing the deleted VFS data structures.

14. The method of claim 13, further comprising:
receiving a request to mount the given file system at a location in the VFS from which the given file system was unmounted by the forced unmount; and
in response to the request, detecting one of the linking data structures mounted at the location in the VFS.

15. The method of claim 14, further comprising:
in response to detecting one of the linking data structures, replacing the linking data structures with additional VFS data structures associated with the given file system,
wherein the linking data structures include a linking mount structure and a plurality of linking nodes and the additional VFS data structures include an additional VFS mount structure representing the given file system and a plurality of additional VFS nodes representing directories of the given file system.
